(19) United States
(12) Patent Application Publication
(10) Pub. No.: US 2012/0104278 A1
(43) Pub. Date: May 3, 2012

(54) System And Method For The Excitation, Interrogation, And Identification Of Covert Taggants

(76) Inventors: Elizabeth A. Downing, Sunnyvale, CA (US); Mark G. Willner, Lafayette, CO (US)

(21) Appl. No.: 13/240,885

(22) Filed: Sep. 22, 2011

Related U.S. Application Data
(63) Continuation of application No. 11/264,849, filed on Nov. 1, 2005, now abandoned.
(60) Provisional application No. 60/624,929, filed on Nov. 3, 2004.

(51) Int. Cl. G01N 21/64

(52) U.S. Cl. 250/458.1; 250/200

(57) ABSTRACT

Apparatuses and methods relating to excitation, interrogation, and identification of covert taggants, are described. In one exemplary embodiment, a multi-measurement interrogator comprising an emitter and an optical sensing subsystem that is capable to sense more than one type of a response signal from a taggant is described. The multi-measurement interrogator may interrogate the taggant multiple excitation wavelengths, acquire more than one type of the response signal from the taggant, and perform quantitative measurements of the response signal. Another exemplary embodiment of the invention describes an eye-safe interrogator that includes a light emitting diode (LED), wherein LED is capable to stimulate one or more of an upconversion fluorescence and a Stoke's fluorescence from the taggant. Another exemplary embodiment of the invention provides a portable, hand-held covert interrogator, which utilizes invisible light both to excite the taggant and to receive a response from the taggant.

This application is a continuation of co-pending U.S. patent application Ser. No. 11/264,849, filed on Nov. 1, 2005, and, claims priority to co-pending U.S. Provisional Patent Application Ser. No. 60/624,929 filed on Nov. 3, 2004, which provisional application is incorporated herein by reference in its entirety; this application claims the benefit of the provisional's filing date under 35 U.S.C. §119(e).

### FIELD OF THE INVENTION

This invention pertains to the field of covert tagging and authentication. More particularly, this invention pertains to the field of identification of upconverting and other optical taggants.

### BACKGROUND

Covert tagging is a way of protecting branded goods, pharmaceuticals, fuels, spirits, clothing, tobacco, electronic parts and components, and other products and merchandise from unauthorized production, distribution, and sale—i.e., against counterfeiting and diversion. There are numerous ways by which covert taggants may be incorporated into a product for a purpose of authenticating it. Covert taggants may be incorporated into a product via printing, applied tags, or other means to assure its identity and authenticity. Covert taggants may be printed directly onto the packaging or the product surface. Covert taggants may also be integrated with labels, laminants and stickers, which may be adhesively applied to the product. In addition, covert taggants may be coated (via painting, dipping, varnishing, embossing, etc.) directly onto a product, or mixed into a product, for example, by injection into molded plastic. Traditionally, fluorescent materials have been used as taggants. FIGS. 1a and 1b schematically show processes of Stoke's and anti-Stoke's fluorescence respectively. In general, fluorescence is a result of a transition of electrons excited by the absorbed radiation from a higher energy level HL to a lower energy level LL. Fluorescent materials that emit Stoke's fluorescence absorb irradiating photons with energy E_{A}, and subsequently, emit or radiate much of the energy as photons of the same or lesser energy E_{R} than irradiating photons (FIG. 1a). Stokes fluorescence is independent of wavelength, but generally is exploited when materials absorb UV, blue, or green photons and emit blue, green, or red light.

FIGS. 2a and 2b show traditional interrogators (readers) for fluorescent taggants. Typically, Stokes fluorescence may be detected with a human eye by illuminating the appropriate material with an ultra-violet light from an incandescent lamp (FIG. 2a). Traditionally, high efficiency UV fluorescers incorporated into inks and coatings and, subsequently, printed onto product labels have been used as taggants for providing a rudimentary level of product authentication. Though easily detected, UV taggants cannot be photocopied and are integrated into many of the world's currencies as a means of thwarting counterfeiting.

Anti-Stoke's (upconversion) fluorescence, in contrast to Stoke's fluorescence, is generally characterized by the absorption of two or more photons with low energies E_{A1}, E_{A2}, etc., followed by the emission of photons with higher energy E_{R} (FIG. 1b). Upconversion fluorescence requires high intensity illumination at specific wavelengths that resonantly conform to discrete energy transitions within the ions. For this reason, upconversion fluorescence cannot be stimulated by incandescent lights and is not readily observed in nature. Like Stoke's fluorescent taggants, small particles of specially formulated upconverting particles may also be integrated into inks and coatings to covertly tag objects. Because they are more difficult to identify on a product, they offer a higher level of security for authentication applications than Stoke's taggants. Current solutions to interrogating upconverting fluorescent taggants use a single infrared laser diode, typically at a wavelength of 980 nm (FIG. 2b) for exciting taggants at one, steady-state excitation wavelength and have no means by which to quantitatively evaluate the taggant signature (response), and are, thus, substantially limited in their usefulness. Because existing devices for interrogating optical taggants do not employ detectors, filters, gratings, or temporal measurement components (elements), they provide only a simple and qualitative measurement capability.

Typically, the human user interprets qualitatively the taggant response. Because the human visual system effectively merges discrete spectral bands into a single perceived color, a human user can only quantitatively detect a limited range of colors. Taggants that emit multi-component radiative signatures containing, for instance, red and green, will appear orange to yellow to a human, depending on the relative intensities of the bands. A human, however, cannot resolve orange into red and green emission bands. Furthermore, humans can only perceive wavelengths that fall within a very limited spectral range, which excludes the ultra-violet and the infrared. Additionally, because the human visual system is particularly slow (anything faster than ˜30 Hz appears continuous), taggants that emit light very rapidly cannot be differentiated from those that emit light slowly, and relative decay rates between different bands of the same taggant can also not be differentiated.

Moreover, because traditional interrogators do not employ microprocessor or programmable gate array controlled input and analysis, communications (wireless network, cell phone), camera (digital still or video), scanning (bar code, RFID) or printing capabilities, they are extremely limited in production, distribution, or sales applications.

In addition, traditional interrogators, except those that utilize lasers, are not capable to interrogate covertly tagged objects from a distance of 0.01 inch or more, and specifically, through external (plastic, paper) packaging. Laser diodes may deliver sufficient optical intensity for this purpose and their beams may propagate over distances of several inches or more. However, diode lasers pose an eye safety hazard because the coherent radiation they emit can be focused to small spots on the retina causing irreversible damage. Light emitting diodes (LEDs) emit incoherent light and consequently, are eye-safe. However, the integrated lenses in LED's current design cause the pattern to be very divergent rather than focused to a high intensity spot that makes the stimulation of the upconversion fluorescence in a taggant impossible. Besides, those existing interrogator devices that employ LEDs require that the lens of the LED be placed very close to or directly touching the taggant, leaving little room to view the response. Taggant measurements taken in this manner are particularly prone to misinterpretation.

Hence, LEDs in their current design cannot be utilized to interrogate upconversion taggants. Moreover, LEDs in their current design cannot interrogate taggants that are at a distance of 0.01 inch or more, or that are not directly accessible, specifically those that are inside packaging, enclosures, show cases, etc. In addition, traditional devices that stimulate upconversion fluorescence are not eye-safe. They merely provide an excitation of the taggant at a single, steady state excitation wavelength and have no means to quantitatively evaluate one or more of the taggant signatures (responses). Moreover, since traditional interrogator devices utilize visual response signals from the taggant, they cannot be used to covertly interrogate a taggant.

### SUMMARY

Apparatuses and methods relating to excitation, interrogation, and identification of covert taggants are disclosed herein. In one exemplary embodiment, a multi-measurement interrogator comprising an emitter and an optical sensing subsystem that is capable to sense more than one type of a response signal from a taggant is described. The multi-measurement interrogator may interrogate the taggant at multiple excitation wavelengths, acquire more than one type of the response signal from the taggant, and perform quantitative measurements of the response signal.

Another exemplary embodiment of the invention provides an eye-safe interrogator that includes a light emitting diode (LED), wherein the LED is capable to stimulate one or more of an upconversion fluorescence and a Stoke's fluorescence from the taggant. Further, the disclosed LED design provides a capability to interrogate the taggant at a distance. Another embodiment of the invention provides an eye-safe LED-based interrogator that is capable of sensing more than one type of the response signal from the taggant.

Another exemplary embodiment of the invention provides a portable, hand-held covert interrogator, which utilizes invisible light both to excite the taggant and to receive a response from the taggant and may operate in an open environment without drawing attention to itself.

Various embodiments described herein may be used to interrogate several taggants and members of a family of taggants. According to one of the embodiments of the invention, the interrogator may communicate with a network computer using wireless networking capabilities, read RFID tags and bar codes to correlate its measurements with inventory and production control software, and print out results, if needed, at the touch of a button. In addition, the interrogator may be a portable device with an AC adapter. Further, the interrogator may record digital, still and video images in the event of questionable taggant responses, which may be used as evidence if a legal matter ensues. It may also provide cell phone communications should the user need to communicate directly while performing inspections.

In another embodiment, a method of multi-measurement interrogation is described, which includes enabling an emitter, emitting a radiant energy by the emitter on a taggant, sensing one or more types of a response signal from a taggant by an optical sensing, measuring one or more of taggant parameters; and identifying the taggant, wherein identifying includes comparing the response signal from the taggant with a sample signal stored in a memory.

Other embodiments of interrogators and interrogating methods are described.

Other features and advantages of embodiments of the present invention will be apparent from the accompanying drawings, and from the detailed description, that follows below.

### BRIEF DESCRIPTION OF THE DRAWINGS

The present invention is illustrated by way of example and not limited by the figures of the accompanying drawings in which like references indicate similar elements and in which:

FIG. 1a shows schematically a Stoke's fluorescence;

FIG. 1b shows schematically an anti-Stoke's (upconversion) fluorescence;

FIGS. 2a and 2b show prior art interrogators;

FIG. 3 shows a block diagram of a multi-measurement interrogator according to one of the embodiments of the invention;

FIG. 4 shows a block diagram of an eye-safe interrogator according to one of the embodiments of the invention;

FIG. 5 is a block diagram of an eye-safe interrogator with an optical sensing subsystem capable of sensing more than one type of a response signal from a taggant according to one of the embodiments of the invention;

FIG. 6 shows possible types of a response signal from a taggant;

FIG. 7 shows possible taggant parameters that are sensed by an optical sensing subsystem according to various embodiments of the invention;

FIG. 8a is a block diagram of a cw emitter with a driver and a focusing optics;

FIG. 8b is a block diagram of an emitter with a focusing optics and a driver capable of modulating the emitter;

FIG. 9a is an optical sensing subsystem for a cw measurement according to one of the embodiments of the invention;

FIG. 9b is an optical sensing subsystem for a time decay measurement according to one of the embodiments of the invention;

FIG. 10 is a block diagram of a multi-measurement interrogator according to one of the embodiments of the invention;

FIG. 11 is a flowchart of one of the embodiments of a multi-measurement method of interrogating a taggant;

FIG. 12 is a flowchart of one of the embodiments of the multi-measurement interrogation method;

FIG. 13 is a flowchart of one of the embodiments of an eye-safe method of interrogating a taggant;

FIG. 14 is a flowchart of one of the embodiments of an eye-safe method of interrogating a taggant;

FIG. 15 is a block diagram of a portable covert interrogator according to one of the embodiments of the invention;

FIG. 16 is a flowchart of a covert interrogation method according to one of the embodiments of the invention;

FIG. 17 is a block diagram of an exemplary multi-measurement interrogator according to one of the embodiments of the invention;

FIG. 18 shows a hand-held interrogator that is capable to focus to a distance greater than 1/100 inch from an interrogator housing according to one of the embodiments of the invention.

FIG. 19 is a schematic diagram of an exemplary multi-measurement interrogator according to one of the embodiments of the invention.

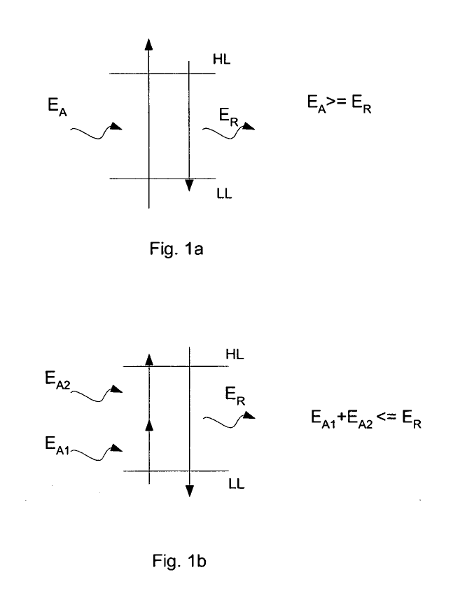

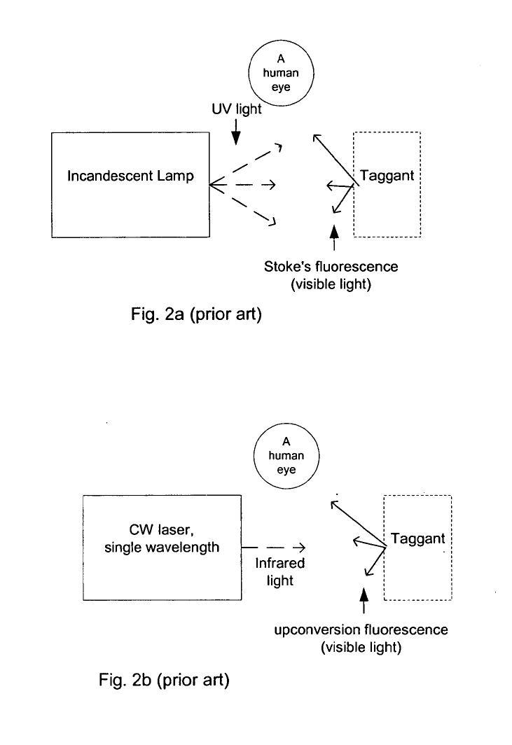

### DETAILED DESCRIPTION

A system and method for the excitation, interrogation, and identification of covert taggants is disclosed. In the following description, numerous specific details are set forth in order to provide a thorough understanding of the present invention. For example, various interrogator configurations are provided for illustrative purposes rather than to be construed as limitations of the present invention. However, it is understood to one skilled in the art that embodiments of the invention may be practiced without these specific details. In other instances, well-known circuits, devices and techniques are shown in block diagram form, rather than in detail, in order to avoid obscuring the understanding of this description.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

Moreover, inventive aspects lie in less than all features of a single disclosed embodiment. Thus, the claims following the Detailed Description are hereby expressly incorporated into this Detailed Description, with each claim standing on its own as a separate embodiment of this invention.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

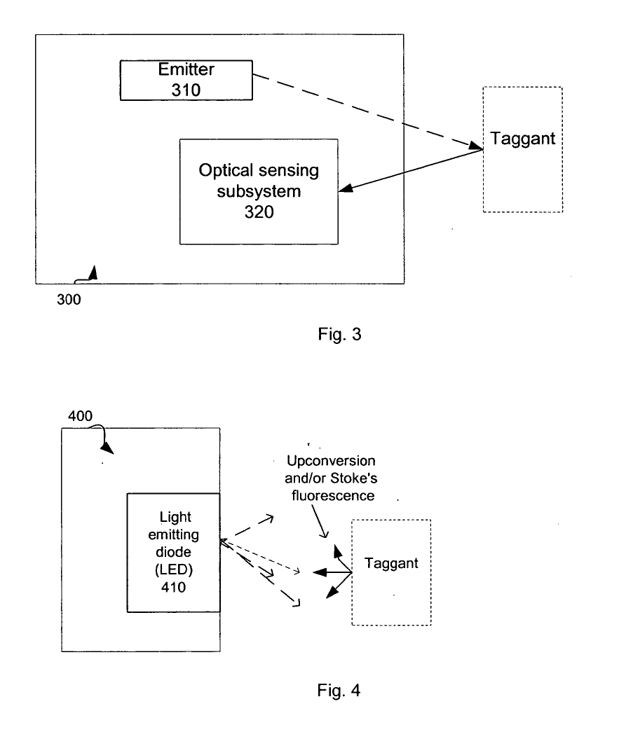

FIG. 3 shows a block diagram of a multi-measurement interrogator according to one of the embodiments of the invention. The multi-measurement interrogator includes an emitter 310 and an optical sensing subsystem 320 that is capable of sensing more than one type of a response signal from a taggant. The interrogator works by emitting radiant energy from the emitter when activated by the interrogating person using the device. The interrogating person may be a factory employee performing QA or inspection of the production or distribution process; he may be a retail clerk verifying the authenticity of returned or serviceable merchandise; he may be a law enforcement or customs official tracking goods; or he may be a legitimate owner or collector of an object of some kind. The person may point the radiative aperture (emitting end) of the interrogator towards the location on the object where the taggant is supposed to reside, thereby delivering photons of one or more of the requisite wavelengths and intensities to the designated location on the item. If the radiation is invisible, a secondary source of visible radiation may accompany the invisible source (along the same optical axis or parallel to it) for the purpose of helping to guide the invisible beam to the proper location on the object. The secondary visible source, such as LED or low power laser may be focused to a simple point, or it may be optically configured to have a specific shape such as a cross hair or a circle. In one of the embodiments of the invention, the secondary visible source may be used as an “ON” indicator that is always turned on when the invisible source is turned on providing an additional level of safety. The interrogator may also include a visible “power on” indicator (LED), which turns on when power is supplied to the emitter and/or when photons are emitted from it.

An emitter 310 may comprise a single light emitting diode (LED), a LED array, or a cluster of individual LEDs (common cathode, common anode, or neither) depending on configuration. The emitter 310 may also include a laser diode, laser diode array, or any combination of lasers and LEDs. Further, the emitter's radiation may be ultraviolet, visible, infrared, or any combination thereof, to suit the requirements of the taggant. In one embodiment, the emitter may be an infrared source, so as to induce upconversion fluorescence in the taggant. In another embodiment, the emitter may emit any combination of infrared, visible (for instance, for aiming purposes or producing visibly induced Stoke's fluorescence) or UV radiation as anti-Stoke's materials may also undergo traditional Stoke's fluorescence at wavelengths substantially compatible with the ground state absorption transition of any emitting level. In one of the embodiments of the invention, a LED may be combined with a laser diode to enable simultaneous interrogation at substantially different distances ranging, for example, from less than one inch to tens of meters or kilometers.

Further, a LED lacks the resonant cavity required for lasing and, as such, emits incoherent electromagnetic radiation in a broader range of wavelengths than a laser diode. The lack of spectral coherence generally makes a LED, unlike a laser, eye safe. When current flows through a laser diode, the spontaneous emission resonates within the faceted minors of the laser diode resulting in a coherent output emission. The mirrors are typically coated so as to reflect only a narrow wavelength portion of the spontaneous emission curve resulting in a much narrower emission bandwidth. By controlling both the reflectivity of the minors and the temperature of the laser diode, which in turn controls the length of the cavity, the wavelength of a laser can be precisely regulated.

In another embodiment of the invention an emitter includes a laser diode with the facets coated such a way as to suppress coherent emission and maximize incoherent emission of the laser. Specifically, a laser diode chip with a high reflective (R=˜100% at) coating on one facet at the proper wavelength, and an antireflective coating (R=˜0% at) on the output coupler enable the laser diode chip to be used as a LED by suppressing the oscillation required to stimulate coherent emission from the cavity. This narrows the spectral bandwidth of the radiant energy and increases the power while still ensuring incoherent eye-safe emission. This super-radiant, edge-emitting device structure is fundamentally different than that of a standard LED.

FIG. 4 shows a block diagram of an eye-safe interrogator according to one of the embodiments of the invention. The eye-safe interrogator 400 includes a LED 410 that is capable to stimulate one or more of an upconversion fluorescence and a Stoke's fluorescence from a taggant.

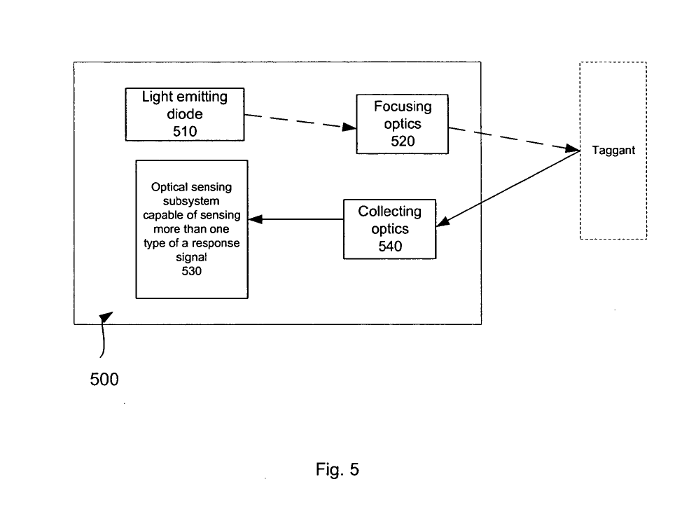

FIG. 5 is a block diagram of another embodiment of an eye-safe LED-based interrogator 500 with a focusing optics 520 in front of the LED 510 and a collecting optics 540 in front of an optical sensing subsystem 530 capable of sensing more than one type of a response signal from a taggant. Several advantages of using a LED 510 instead of a laser diode to irradiate taggants include typically the reduced cost of the LED's, simpler circuitry, and the avoidance of radiated coherent emission, which is a known eye safety hazard, particularly for non-visible wavelengths. A LED emits incoherent optical radiation as a point source and, thus, cannot be focused to diffraction-limited spots on the retina. This enables LED-based interrogators to be used by individuals with minimal training, in much the same manner as one would use a flashlight. The safe use of these LED-based devices for optical interrogation is a tremendous benefit over similar laser diode based interrogators. In one embodiment, a commercially available LEDs such as Roithner Lasertechnick, Austria, which have an integrated plastic lens as part of the assembly, may be integrated into the interrogator. In another embodiment, a bare semiconductor chip LED that is mounted on a heat sink with no integrated lens may be incorporated into the interrogator. An advantage of using a LED without integrated plastic lenses is that a focusing optics 520, for example, a lens may be placed very close to the emitting aperture of the chip. This enables the lens to be small and inexpensive, and to closely match the numerical aperture of the chip. Placing a short focal length lens close to the chip also enables more of the emitted light to be collected by the optical system, delivering a substantially high intensity spot to the taggant.

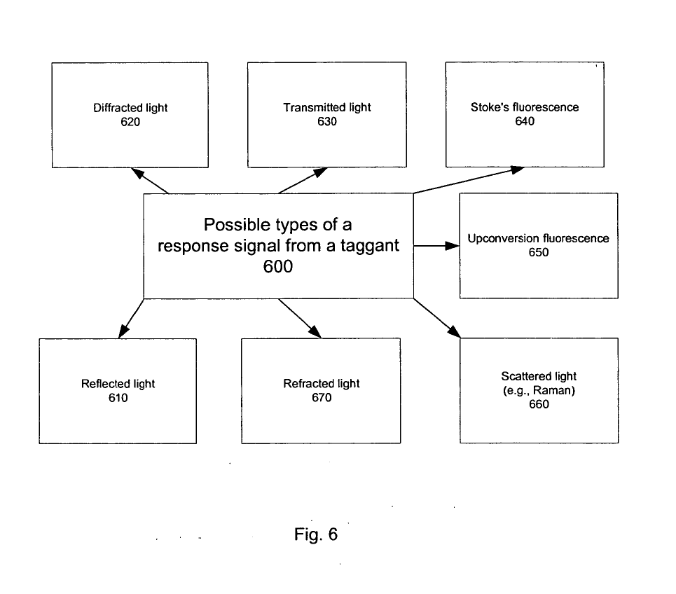

FIG. 6 shows possible types of a response signal 600 from a taggant. The taggant may respond by absorbing the light from the interrogator, by reflecting the light, by refracting or diffracting the light, and/or by scattering the light. Consequently, the type of the response signal from the interrogator may be a reflected light 610, a diffracted light 620, a transmitted light 630, a Stoke's fluorescence 640, an upconversion fluorescence 650, a scattered light (e.g. Raman fluorescence) 660, and a refracted light 670. The response light signal from the taggant may be at the same (or very similar) wavelength (e.g., Stoke's fluorescence), or at one or more substantially different wavelengths (e.g., upconversion, Raman fluorescence), depending on the mechanisms involved into the interaction between the light and the taggant. The taggant, if present and if authentic, may interact with the radiant energy (absorb, scatter, reflect, refract, etc.) and generate a response light signal at a similar or different electromagnetic frequency. In addition, the direction of the response signal may differ from the direction of the radiant energy. The response light signal may be a result of Stokes' fluorescence, Raman fluorescence, upconversion fluorescence, refraction, diffraction, scattering, or some other optical phenomenon. Alternatively, if part of the function of the taggant is simply to absorb light at the emission frequency, then the lack (or reduction thereof) of the excitation source being returned to the detector upon reflection may also be quantified.

Covert taggants may have many optical properties and it is important to be able to expose the taggant to the proper optical stimulation, in a controlled manner, in order to accurately measure all necessary properties of the emission. As it was mentioned above, covert taggants may be integrated into an item via a number of mechanisms. One way of doing so is to print the taggant directly onto the surface of the product or it's packaging with an ink (or coat/apply a laminant) that has been embedded with the taggant. Such inks may be transparent, or may have other pigments incorporated to give them color or additional covert properties. A dry taggant may be mixed into liquid ink, then homogenized using any number of mixing techniques including ball milling, vortex mixing, shaking, stirring, rolling, folding, etc. A nondry taggant may also be integrated into the ink. Surfactants and suspension agents may be added to the ink/taggant mixture to reduce particle agglomeration and to inhibit settling or floating of the particles. This helps to keep the taggant particles in a more uniform loading during the printing process so that a substrate printed during the beginning of a process run has a similar loading as a taggant printed during the end of a process run. Using an ink mixture that has a similar density as the taggant also helps keep the taggant particles in suspension. Additionally, the ink may be stirred or recycled during the printing process to better effect even particle distribution. Several printing processes may be used to apply the taggant including flexographic, gravure, ink jet, laser, (silk) screen-printing, intaglio, offset, or any other printing process. This enables the taggant to be applied to the product in a very controlled manner at the final stages of manufacture, thereby controlling its distribution.

Another way to integrate the taggant onto the product is to apply a label that has been printed or otherwise integrated with the taggant. Such labels may include a simple substrate material that has been printed, or may include a more complex substrate material such as holographic film, or a layered material with other covert properties such as magnetic or other covert or overt optical signatures. In addition, the labels may have overt information printed or applied to them such as the brand name, make/model, size, expiration date, place of manufacture, bar code, price, or any other information. The covert taggant may also be printed onto the product to make a hidden or covert bar code. Reasons for doing this may include the need to retain its covert location, or simply to remove an unsightly, but needed informational content label. Labels may be applied adhesively using a number of techniques including magnetic, pressure adhesive, sticky adhesion, thermal adhesion, electrostatic adhesion, sewing, gluing, taping, etc. In addition to printing, the taggant may be sprayed or otherwise coated onto the surface of an item. Alternatively, an item may be dipped into or rolled through solution mixtures of taggants or mixed taggants.

In addition to applying the taggant directly via a printing process or a label, covert taggants may be integrated directly into paper, plastic, metal, ceramics, fabric, textiles, leather, wax, shellacs and varnishes, paints, and other materials by introducing them during the manufacturing stages. For instance, the taggant may be added to a polymer or monomer mixture, or applied directly to a mold, prior to the final curing stage, and allowed to set up into the final product. This enables parts to be molded with taggant particles in them. Since colored parts receive little benefit from the taggant that is incorporated into the inner structure of colored plastic components, forcing the taggant to the surface by letting it settle or stick to the edges of the mold may help to keep it in a location that is productive for inspection. Taggants may be incorporated into transparent polymers, and may be integrated with other pigments in polymers to add color. Multiple taggants can also be integrated together in order to provide multiple interrogation mechanisms in a single or layered substrate. Very small taggant particles can be integrated with index matched (matched to the cured material) mono-or polymers to make a material that is very transparent when cross-linked or cured. Matching the refractive index of the taggant to the polymer and keeping the particles small reduces or even eliminates Mie scattering of electromagnetic wavelengths smaller than the particle diameter. The closer the taggant particle morphology is to being spherical, the more closely the mixture conforms to the Mie scattering theory.

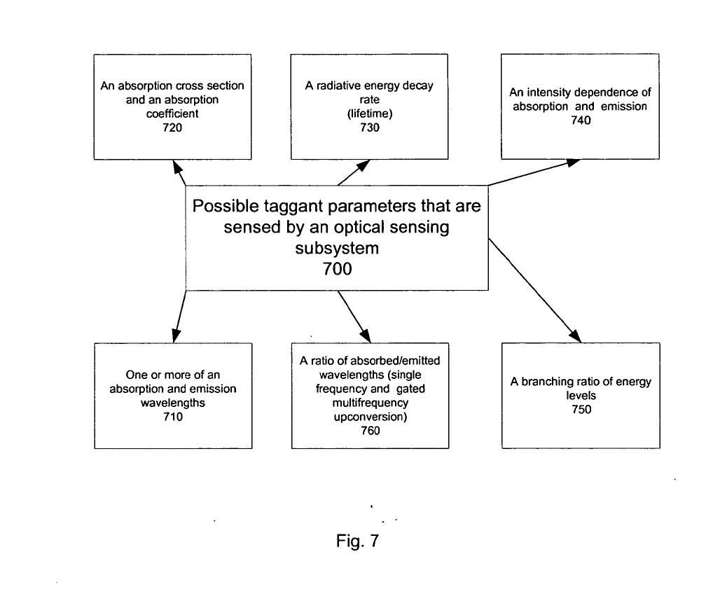

FIG. 7 shows possible taggant parameters 700 that may be sensed by an optical sensing subsystem. Taggant parameters to be interrogated include one or more of an absorption and emission wavelengths 710, an absorption cross section and absorption coefficient 720, temporal parameter, such as a radiative energy decay rate (lifetime) 730, an intensity dependence of absorption and emission 740, a branching ratio of energy levels 750, a ratio of absorbed to emitted wavelengths including multi frequency upconversion (single frequency and gated multi frequency) 760.

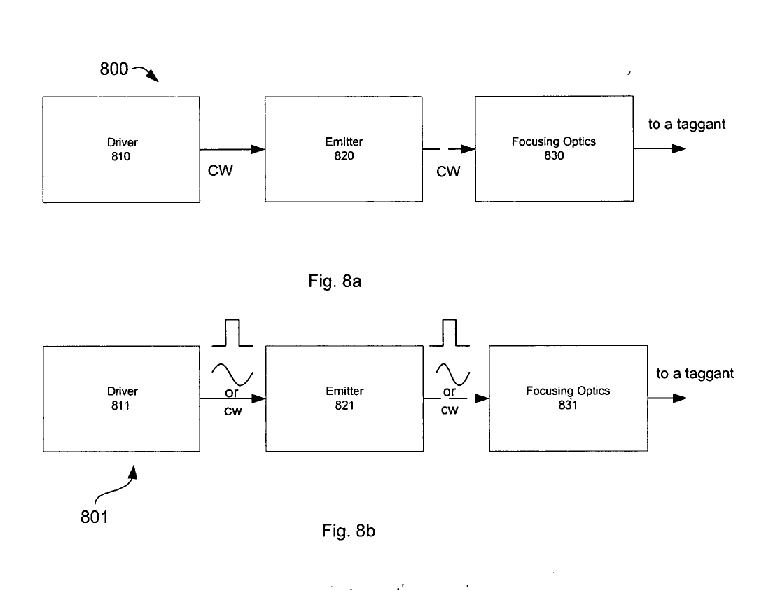

FIGS. 8a and 8b show block diagrams of the emitter with a driver and a focusing optics, according to various embodiments of the invention. The emitter is driven by a driver circuit that [B1] that enables the continuous wave (cw) 800 or modulated 801 emission from the emitter. LEDs behave like ordinary diodes but with a forward voltage drop typically in the range of 1.5 to 2.5 volts. The forward voltage drop is determined by the energy band gap of the semiconductor material from which a LED is fabricated. Typical LEDs are made of such semiconductor materials as gallium arsenide, gallium phosphide, and gallium nitride having the energy band gap larger than it is in silicon. Unlike broad-spectrum fluorescent and incandescent lamps, which emit a large proportion of their radiant energy in non-usable spectral bands, LEDs have narrow band emission (around 100 nm) that makes them electrically more efficient, with lower heat dissipation requirements than for lamps. This enables them to be easily driven in electronic circuits by bipolar TTL, CMOS, and NMOS logic. Appropriate buffering may be used for logic with poor current sourcing or sinking capabilities, especially for high brightness LEDs that require large currents. On FIG. 8a an emitter 820 is driven by a driver 810 to produce cw light that is then being focused by a focusing optics 830, according to one of the embodiments of the invention. FIG. 8b is a block diagram of an emitter 821 with a focusing optics 831 and a driver 811 that is capable of modulating the emitter. In one embodiment, modulation of the emitter may be used to detect a substantially weak signal from the taggant. In another embodiment, modulation of the emitter by pulses may be used for time-resolved measurements. Multiple devices of different wavelengths and different structures may be driven by the driver and controlled independently or simultaneously with the same frequency and duty cycle to interrogate a taggant. Individual driving circuits for each light source that comprises the emitter may enable different pulse widths and duty cycles, the individual pulses may overlap in time enabling single frequency and multi-frequency optical responses, such as gated multi-frequency upconversion and cross-relaxation upconversion from the taggant. Multiple interrogation methodologies enable extremely thorough interrogation of the taggant to be performed thereby completely differentiating it from counterfeits which may have a similar response to a single measurement methodology such as the emission of visible light when excited by a particular infrared wavelength. Some LEDs may require current limiting resistors and some of them have the limiting resistors installed. A laser diode requires protection circuitry to minimize electrostatic discharge, which damages the facets and degrades the output power.

Focusing optics 830 and 831 may be used to focus electromagnetic radiation to enable sufficient energy density (intensity) that is defined as the amount of radiant power per unit area to be delivered to the taggant to induce the intended optical response. Since fluorescence originates from photons that are emitted by a material as excited electrons decay from higher to lower energy levels, the greater the number of electrons that can be excited to the requisite high levels, the more photons will be emitted. Dipole transition rates are governed by intensity so the smaller the area of the focused spot, the higher the transition rate of the electrons in the taggant material between the energy levels, for any given power level of the excitation source. The larger the number of electrons transferred to higher energy levels, the greater the signature (response) strength of the emitting taggant.

Refractive optics (e.g., one or more lenses) may be used as elements of the focusing optics 830 and 831. Such optical elements may be made from crystals, glass, or numerous injection-molded plastics, and can be spherical or aspherical, cylindrical, single or multi-element (such as cemented doublets), coated (anti-reflection or bandpass for instance), or otherwise optimized for transmission of specific wavelengths. Light may also be focused diffractively using gratings such as holographic gratings, or via reflection off of curved surfaces such as parabolic or spherical reflectors. The reflectivity or transmission of optical elements can often be increased with narrow band coatings.

The individual emitting element may be individually focused using a different focusing optics for each one, like individual micro lenses for each light source. Conversely, multiple emitting elements (including the aiming laser) may be focused simultaneously using the same optical system. This may be accomplished by placing multiple emitting elements in the same object plane, at appropriate spatial distances, and focusing them all with the same optical system such as with a single lens. The light from the different emitting elements may be focused onto different image planes as a function of their wavelengths, and may be separated in this plane by a distance proportional to their initial spacing and the magnification and imaging properties of the optical system. The spot sizes from the emitting elements in any single focal plane are a function of their emitting apertures, wavelengths, and the focusing optics' magnification. Additionally, the photons from different emitting elements may be superimposed onto one another to provide for simultaneous multi-wavelength excitation in the same region of a substrate where a taggant may be embedded. Multi-wavelength excitation may be enabled by polarization coupling through a polarizing filter or polarizing beam splitter, or wavelength coupling through a narrow band reflector that passes one wavelength, but reflects the other at a 45° (or other) incident angle.

In one of the embodiments of the invention, a LED of one wavelength focused at a few inches, combined with a higher power laser diode focused at 30 feet, may enable the interrogator to interrogate near and far objects with a simple input command function.

The response signal from the taggants may be collected and quantified in terms of intensity, wavelength, and duration (lifetime).

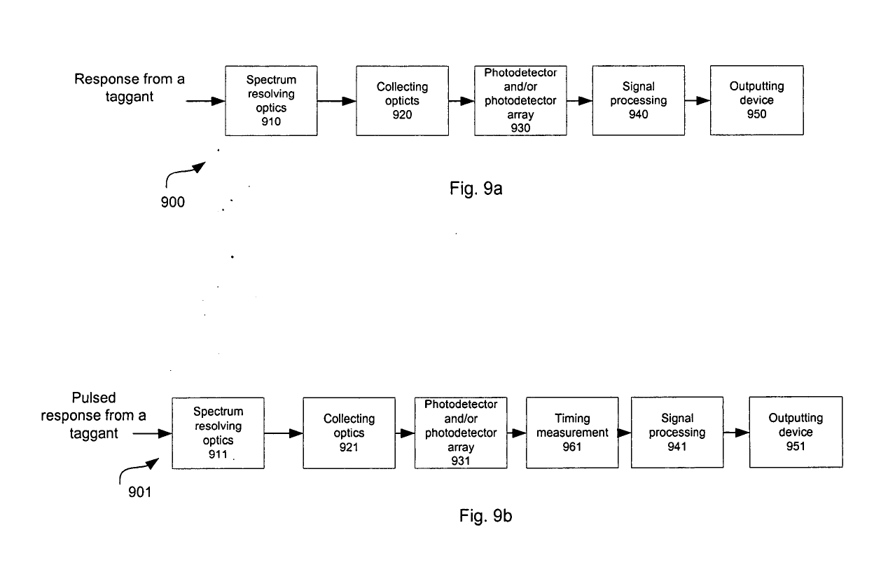

FIGS. 9a and 9b show various embodiments of the optical sensing subsystem for a cw measurement 900 and a time-resolved measurement 901 correspondingly. The response signal from the taggant may be resolved by a spectrum resolving optics 910, 911; collected by a collecting optics 920, 921; measured by one or more photodetectors and/or photodetector arrays 930, 931; processed by a signal-processing unit 940, 941; and then output by an output device 950, 951. The greater the signal, the less amplification is required to perform the measurement. Collecting optics may be employed to gather a larger cone angle of light from the substrate with the embedded taggant than would otherwise reach the detector. Whereas the projection (focusing) optics of the emitters need not be large in diameter, the collecting optics should be as fast as necessary to increase the signal to noise ratio of the detection system. In another embodiment, the collecting optics 920, 921 may further comprise an optical band pass filter placed in front of the detector to selectively limit the center frequency and width of the radiation that impinges on any detector. Multiple detectors, each with a different filter pass band, combined with multiple wavelengths of excitation may enable a high degree of characterization of the taggant material. In another embodiment, multiple detectors are replaced by one detector with multiple filters that are placed in front of the detector on a staging device such as a mechanical wheel. In another embodiment a gradient bandpass filter such as (Oriel used to make one in the 1980s), or a (blazed) diffraction grating, may be placed in front of a pixilated linear photodetector array. In any embodiment, the purpose is to separate the light emitted from the taggant into spectral bands so that the bands may be individually characterized against the excitation energy.

Thus, the optical sensing subsystem may comprise one or more photodetectors and photodetector arrays to measure the response signal. A typical photodetector is made of a semiconductor material. Electromagnetic radiation causes ionization in semiconductor materials, producing charge pairs in the exposed base region of a diode made from the material. This mimics the effect of an externally applied base current. Thus, a diode junction acts like a photodetector. Photodetectors are often packaged in cases with transparent windows to enable light to impinge directly onto the chip. The amount of photocurrent generated by the photodetector is a direct indication of both the wavelength of the incident radiation and the number of photons impinging on it, and is related by the responsivity of the semiconductor material. Different semiconductor materials provide sensitivity to different regions of the electromagnetic spectrum. Silicon is sensitive between 250-1100 nm, whereas GaAs is sensitive between 800 nm and 2.0 microns. Other semiconductor materials such as Germanium, InSb, InAs, and PbSe are also commonly used. The photocurrent, when dropped across a resistor (Horowitz and Hill circuit diagrams), is converted to a voltage which can be directly measured, compared, digitized, or otherwise used to indicate the strength of the impinging bandwidth of light. Proper placement of the photodetectors, if more than one is to be used, must be factored into the design of the detector so that the collection efficiency of the various bands is known or normalized. This is because the taggant embedded substrate emits light isotropically in a near point source configuration and detectors that are farther away from the point of emission will necessarily receive a lesser overall amount of signal (lower numerical aperture). By properly accounting for the collection efficiency of the various filter bands, an accurate analysis of the emission spectrum may be made. To maximize the signal-to-noise ratio, in addition to optimum placement of filters, the collecting optics and detector relative to each other and to the signal, the biasing and drive circuitry of the photodetector may be optimized. Photodiodes generate photocurrent when exposed to light whether or not a bias voltage is applied. Thus, they may be coupled directly to op-amp summing junctions or back biased. In addition to using photodiodes, phototransistors and other detectors may be used to sense the response signal.

The taggant-embedded substrate material exposed to the radiant energy, may respond by absorbing radiant energy from an emitter and emitting electromagnetic radiation at various wavelengths. This may happen even if the excitation energy first propagates through some thickness of packaging material such as plastic window or blister pack. The multiband emission signature results from electrons falling from different levels to the ground state, electrons falling from the same state to different lower levels, and combinations thereof. Depending on the excitation frequency, the fluorescence may be Stokes' fluorescence, upconversion, Raman, or combinations thereof. The taggant typically emits incoherent light, isotropically, and with a random polarization. The response signal characterizes both the taggant's composition and the taggant's processing. By analyzing the emission characteristics resulting from single or multi-wavelength excitation, a taggant may be identified and verified as authentic or counterfeit. According to another embodiment, the lifetime of different emission bands that originate from different upper state levels is measured by timing measuring circuit 960 and used to characterize and differentiate the embedded taggant material.

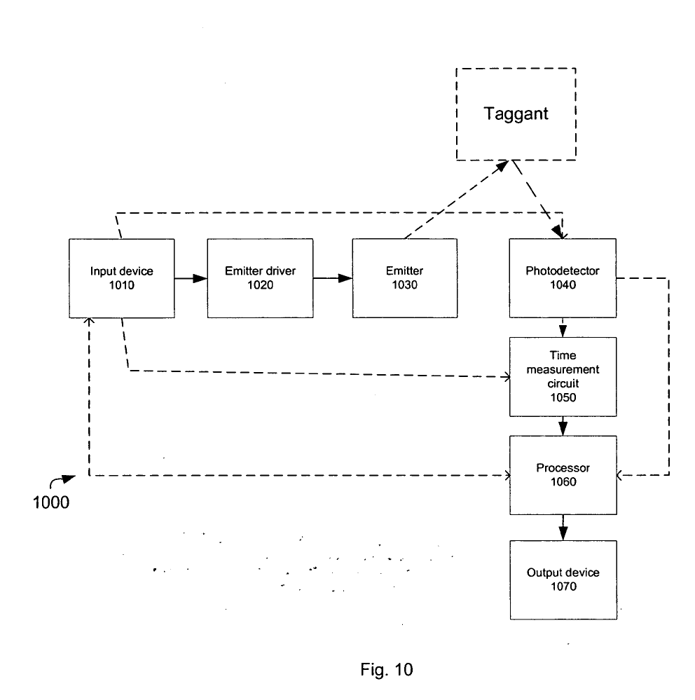

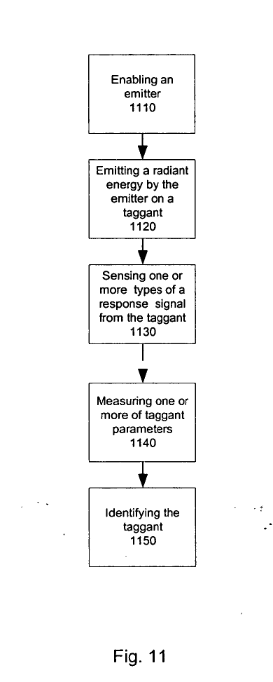

FIG. 10 shows a block diagram of a multi-measurement interrogator according to another embodiment of the invention. An input device 1010 such as a keyboard or one or more buttons may be used to enable the user to instruct the interrogator device as to what taggant, part, label, or product is being interrogated so that the interrogator knows what measurement to perform and what signature look up table or performance parameters to compare the data to. In one embodiment, the input device may be a simple switch. According to another embodiment, to interrogate several taggants by the same interrogator device, a keyboard and a display may be necessary to specify the taggant to be characterized when the switch is depressed. The input device may also be a position selectable switch, or may be a voice input, if voice recognition software is integrated into the interrogator. According to another embodiment, the input device includes a FRID, or a Bar Code reader, or both, to allow taggant reading to be immediately coupled to serial numbers, production lots, manufacturers, distributors, and other relevant tracking, production, and inventory information.

Further, the input device activates an emitter driver 1020 causing an emitter 1030 to emit radiant energy onto a taggant. At the same time, the input device activates a photodetector 1040 to measure a response signal from the taggant. The emitter driver 1020 includes appropriate drive electronics to enable the emitter 1030 to produce a continuous emission (cw), a pulsed emission, or both. In one embodiment, the emitter 1030 may include one or more light sources, such as LEDs of various visible and invisible wavelengths for stimulating one or more taggants. In another embodiment, in addition to the LED, the emitter may include other light sources, such as one or more laser diodes for the same purpose. In another embodiment, the emitter 1030 may further include an appropriate optics for focusing the light emitted from one or more light sources.

Further, the photodetector 1040, according to one of the embodiments, may include one or more detectors and detector arrays for sensing stimulated signal light (response) from the taggant. In another embodiment, the photodetector may be a silicon photodiode. In another embodiment, the photodetector 1040 may include one or more optical filters to enable the detectors to sense selected portions of the optical spectrum of the response signal. Further, the photodetector may include one or more gratings, prisms, or both, to spatially disperse the optical spectrum of the response signal. In another embodiment, one or more detector arrays may be used to sense a spatially distributed optical spectrum.

Further, according to one embodiment, the pulsed signal from the photodetector 1040 is directed to a time measurement circuit 1050 for a time-resolved measurement. In another embodiment, the time measurement circuit 1050 may include one or more temporal filters (or software capability for doing so) to enable time decay (radiative lifetime) of the response signal to be measured. In another embodiment, the time measurement circuit 1050 facilitates the intensity measurement at one or more wavelengths of the response signal as a function of time. It may be performed by monitoring the voltage across the photodetector, wherein the photodetector may be a photodiode, phototransistor, or some other detector. The voltage will be proportional to the photocurrent generated at the pn (or other) junction of the photodetector, and is a direct indication of the number of photons impinging on it if the photodetector operates in a linear, unsaturated regime.

Further, the signal may be processed by a processor 1060 that may comprise a central processor, one or more microprocessors, one or more programmable gate arrays, or other devices with appropriate software, firmware, and operating systems to provide data acquisition, measurement, analysis, stored data tables, pass/fail, and identification feedback to the user or the user's network. Additionally, the processor 1060 may control the elements of the interrogator device, for example, direct the emitters to turn on and off in an appropriate sequence, accept input from the user through an input device, if the one interrogator is to be used to interrogate more than one taggant. Further, the processor 1060 may output the signal to an output device. In one embodiment, the output device may include a printer, a display, one or more indicator lights, an acoustic output component (buzzer), or the combination thereof, to provide feedback to the user. The displayed or printed out information may include, for example, the information on counterfeit goods with relevant characteristics, such as time, date, lot number, part number, style, etc. In addition, the output device may provide wireless or wired communications capabilities to an external computer or a network. Further, the output device may include a digital camera for recording; for example, objects that fail the taggant test and are suspect of being counterfeit. Further, the output device may include a cell phone to communicate, for example, with law enforcement, customs, factory, or corporate personnel.

FIGS. 11-14 show flowcharts of various embodiments of various methods of interrogating the taggant. FIG. 11 shows an example of a multi-measurement method of interrogating the taggant. The method starts from enabling an emitter 1110 by any means described above. The next operation 1120 includes emitting a radiant energy by the emitter on a taggant. In one embodiment, it may include emitting one or more excitation wavelengths from the emitter on the taggant. Further, it may include focusing the radiant energy on the taggant by a focusing optics. Further, a multi-measurement interrogating method includes an operation 1130 sensing one or more types of a response signal from the taggant by an optical sensing subsystem. In one embodiment, the one or more types of the response signal may include Stoke's and anti-Stoke's fluorescence from the substrate and embedded taggant respectively. Further, the method includes measuring one or more of the taggant parameters 1140 by the optical sensing subsystem. In one embodiment, one or more of the taggant parameters may include resolved spectral components and radiative decay rates. Further, the method includes identifying the taggant 1150. In one embodiment, a human user may identify the taggant by observing a visible response, for example, a visible upconversion fluorescence from the taggant. Presence of the visible, for example, green fluorescence would indicate a positive response (i.e., that the product is authentic), and lack of such visible green would indicate a failure (i.e., a possible counterfeit). In another embodiment, identifying an item or product as being authentic includes detecting, quantifying, and analyzing the optical or other (for instance, magnetic) properties of a taggant that has been applied to known regions of it, of its packaging, or of some other substrate material on it such as a tag or label. More specifically, identifying includes comparing the measured properties of the taggant in question to the known properties of the authentic taggant stored in a memory of the processor. Further, comparing the measured properties of the taggant in question to the known properties of the authentic taggant may be performed by a processor or logic array memory, which have been preprogrammed (in firmware) with the correct signal response. Further, comparing the measured signal with that stored in a memory may be performed by using a lookup table or by signal processing of a stored array, for example, with a convolution algorithm. Further, for taggants that are manufactured in batches, a comparison to stored values may include batch-processing tolerances of the taggant, which takes into account the fluctuations in taggant parameters resulting from the manufacturing processes. A match would result for a direct correlation, or a close correlation that is still within the established tolerance range. A failure would nominally result if a signal could not be detected (indicative of no taggant where it should be), or if the signal did not correlate to the stored signal (an indication of counterfeit taggant).

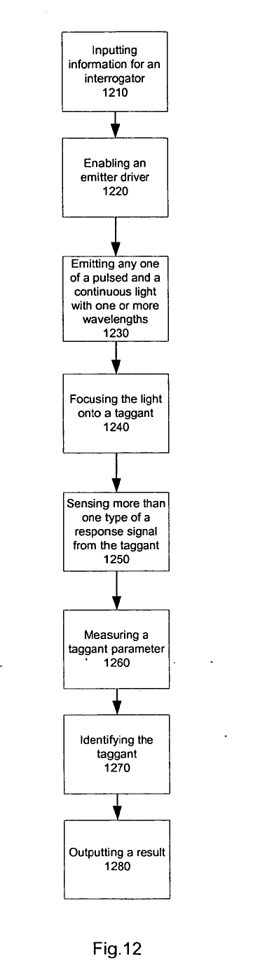

FIG. 12 is a flowchart of another embodiment of the multi-measurement interrogation method. The method includes inputting information for an interrogator 1210, enabling an emitter driver 1220, then emitting any one of a pulsed and a continuous light with one or more wavelength 1230, focusing the light onto a taggant 1240, sensing more than one type of a response signal from the taggant 1250, measuring a taggant parameter 1260, identifying the taggant 1270, and outputting a result. In one embodiment, outputting the result may be enabled, for example, by an LED indicator light, such as a green light for “PASS” and red light for “FAIL”. In another embodiment, outputting the result may be enabled by an appropriate audible alarm, for example, a ping for “PASS” and a buzzer for “FAIL”. In another embodiment, PASS/FAIL information may be transmitted to the user with an integrated display by displaying alphanumeric characters (words), in any appropriate language.

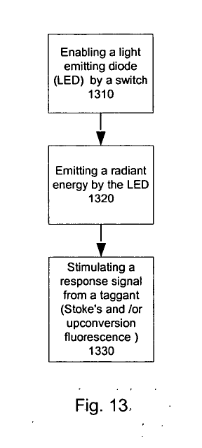

FIG. 13 is a flowchart of one of the embodiments of an eye-safe method of interrogating a taggant. It includes enabling a light emitting diode (LED) by a switch 1310, emitting a radiant energy by the LED 1320, stimulating a response signal from a taggant, such as one or more of Stoke's and upconversion fluorescence 1330.

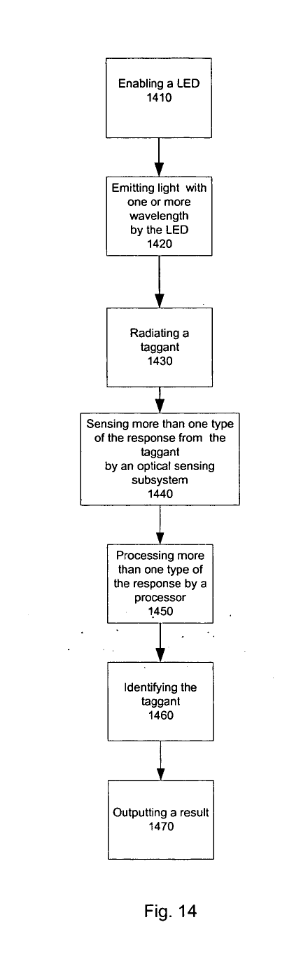

FIG. 14 is a flowchart of another embodiment of an eye-safe method of interrogating a taggant. It includes enabling a LED 1410, emitting light with one or more wavelengths by the LED 1420, radiating a taggant 1430, sensing more than one type of the response signal from the taggant by an optical sensing subsystem 1440, processing more than one type of the response signal by a processor 1450, identifying the taggant 1460, and outputting a result of interrogation by an outputting device 1470.

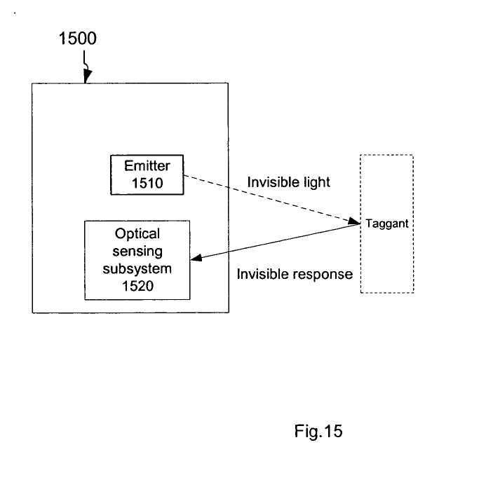

FIG. 15 is a block diagram of a portable covert interrogator 1500 according to one of the embodiments of the invention. The portable covert interrogator may be used in an open environment without drawing attention to itself as such a device. It includes an emitter 1510 that emits invisible light to interrogate a taggant and an optical sensing subsystem 1520 that is capable of sensing one or more types of the invisible response signals from the taggant. In one embodiment, the light emitted by the emitter is infrared. In another embodiment, design of an emitter (laser diode or LED) to focus emitted light to distances of several feet or more may enable the interrogator to interrogate objects far away and in a covert manner, if necessary. Further, the covert interrogator may include a camera as a viewfinder to follow the position of the invisible excitation light. According to various embodiments, the camera may be integrated into the interrogator or may be attachable. It may be used both as a recording device and as a viewing device, because the Si based image chip is sensitive to infrared wavelengths well beyond what the eye can actually see. In this manner, long wavelength eye-safe IR lasers may be used to interrogate boxes in warehouses, with the knowledge of nearby individuals. The integrated wireless communications capabilities may even allow recorded data to be transmitted outside of the building to a more permanent location to save on memory, or to provide a safe receptacle for evidence. The taggant response in this case could also be invisible to humans but would still be measurable by the detectors.

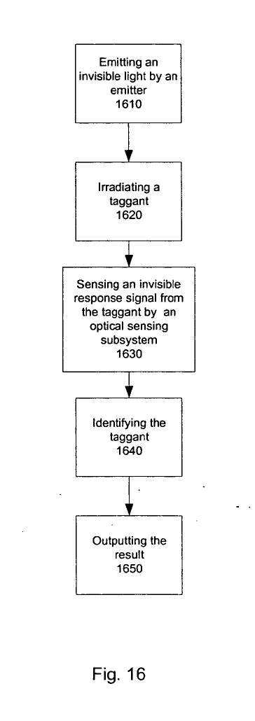

FIG. 16 is a flowchart of a covert interrogation method according to one of the embodiments of the invention. It includes emitting an invisible light by an emitter 1610, irradiating a taggant 1620, sensing an invisible response signal from the taggant by an optical sensing subsystem 1630, identifying the taggant 1640, and outputting the result of interrogation 1650.

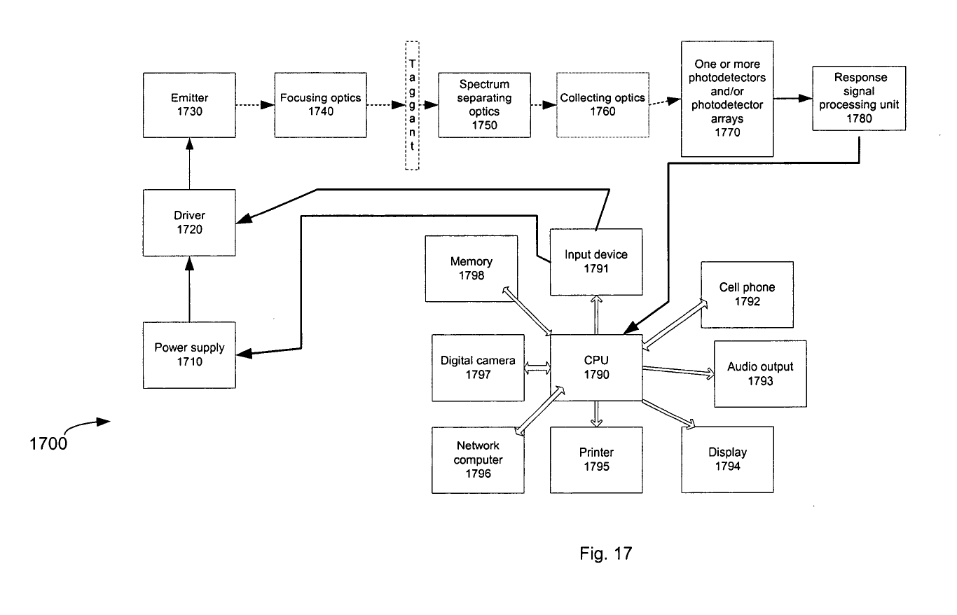

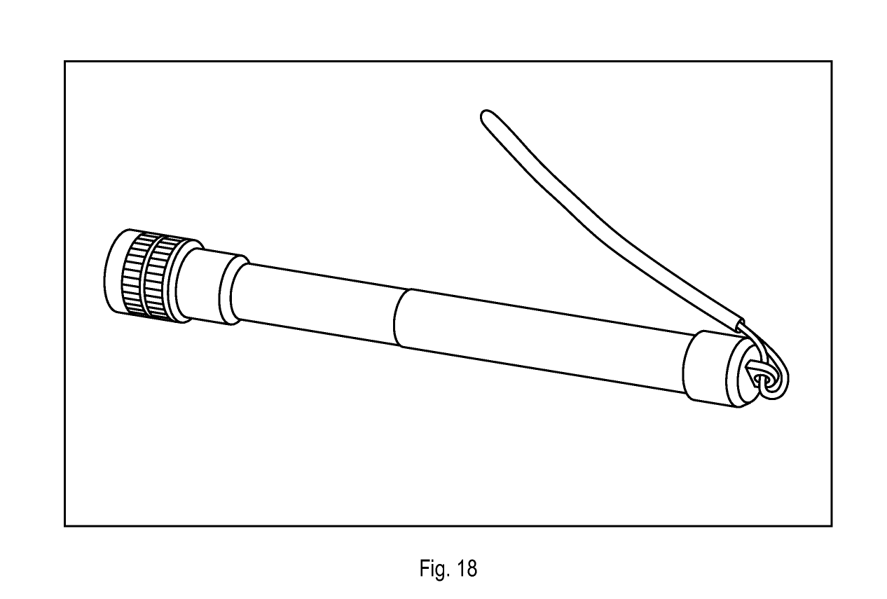

FIG. 17 is a block diagram of another exemplary multi-measurement interrogator 1700. The power supply 1710 enables an emitter driver 1720 that drives an emitter 1730 to emit the radiant energy onto a taggant. The radiant energy may be focused onto a taggant by a focusing optics 1740. The optical spectrum of the response signal from the taggant may be spectrally resolved by a spectrum separating optics 1750. The spectrum separating optics 1750 may comprise one or more of optical filters to select portions of the optical spectrum. Further, the spectrum separating optics 1750 may comprise of one or more gratings, such as a diffraction grating, a refraction grating, a holographic grating; and one or more prisms to spatially disperse the optical spectrum. Further, the signal from the taggant may be collected on one or more photodetectors or photodetector arrays 1770 by a collecting optics 1760 to increase signal to noise ratio. The photodetector array may comprise any one of the linear diode array, or area diode array, or both. The signal is then measured by the photodetector 1770 and conditioned by the signal-processing unit 1780. The processed signal may then be sent to the CPU for further identification. The CPU may control and communicate with an input device 1791, a cell phone 1792, an audio output 1793, a display 1794, a printer 1795, a network computer 1796, a digital camera 1797, and an external memory 1798. Further, the CPU may control the power supply 1710 and the emitter driver 1720 through the input device. In addition, the power supply 1710 may include a battery, wherein the battery may further include a charging receptacle to enable the interrogator to be charged or run off of auxiliary AC power (i.e. with a transformer).

FIG. 18 shows an example of a hand-held, eye-safe interrogator device that may be focused to a distance greater than 1/100 inch from an interrogator housing, according to one of the embodiments of the invention. The interrogator may be packaged in any number of ways that provide for the interrogation light to exit and be delivered to the taggant, and for the signal light to enter and be delivered to (impinge on) the appropriate sensors. Depending on the device's design, a single measurement may be taken, or multiple measurements may be taken simultaneously or sequentially. A user may interrogate an object by pointing the device towards the area on the legitimate product where taggant is supposed to have been applied, pressing a button to turn the interrogator LED on, and observing the response of the taggant. In one embodiment, the interrogator device may be packaged in a small, battery-powered, hand held device that resembles a pen (see FIG. 18).

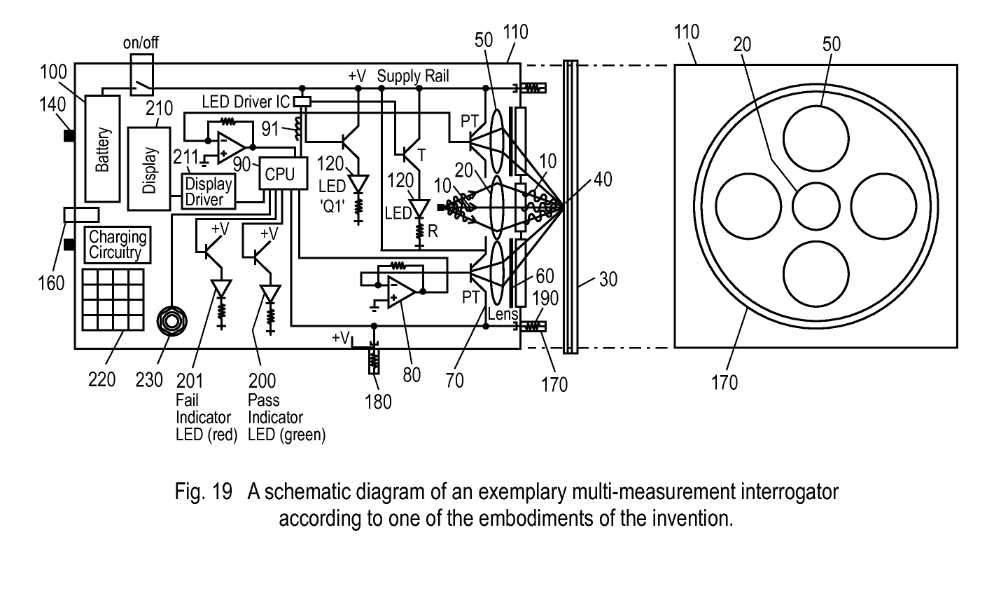

FIG. 19 is a schematic diagram of an exemplary multi-measurement interrogator according to another embodiment of the invention. In one embodiment, an emitter 1, for example, an LED with or without a laser, is collimated or focused by the appropriate optics 20 onto an interrogated area 40 of a taggant 30. A collecting optics 50 in front of one or more detectors 70 may be used to image the signal energy and increase the collection efficiency. Because it is difficult to completely filter out ambient light during distance measurements, modulation of the excitation signal 91 (preferably at other than 60 Hz and harmonics thereof), and subsequent lock-in detection at the same frequency would provide a means to employ temporal filtering. In addition to the measurement of emission wavelengths and ratios thereof, the lifetimes of the various emitted bands may also be measured to further characterize the taggant. This may be done by emitting a pulse of radiant energy and looking at the strength of the various emission (response) bands as a function of time after the pulse has ended. As each emitting level has a characteristic radiative lifetime, the lifetimes of the different levels can, thus, be measured and used as a means of identifying authentic vs. counterfeit taggants, even when the emission lines appear to be similar in either wavelength or strength. In one embodiment, the interrogator is intended to be a lightweight, portable, handheld unit for an user to carry on site to perform quick and accurate inspections of labeled items. In another embodiment, the interrogator may be an OEM unit that attaches to a machine during some stage of the manufacturing or transport process, or during some inspection operation such as in the sorting of money. The interrogator device may be powered by (rechargeable) batteries 100 and 140 or by AC 160 (via a transformer). In one embodiment, the hand-held unit is placed against a surface of the item so as to activate the emitter 1, detector 70, and measurement algorithm (FIGS. 11-14 and FIG. 16) by depressing, for example, a switch 190, which is contained in a light-shielding shroud 170. In another embodiment, an input device such as a keyboard 220 and display 210 may be necessary to input additional information about the taggant. One or more bandpass filters 60 may be placed in front of the detector to select the spectral band of the response signal and to increase the signal-to-noise ratio. These filters may be affixed, or movable (i.e. as in a filter wheel) depending on the embodiment. The shielding shroud may further increase signal-to-noise ratio. The shielding shroud may perform two functions, the first is to prevent or minimize stray ambient light from interacting with the taggant during the measurement and the second is to limit ambient spectral contributions to the taggant signal in response to the emitter excitation that may contribute false signal strength to the taggant analysis. Further, the detector CPU or logic array memory 90 may compare the measured electrical signal from the detector circuit 80 with that stored in a memory. A green 200 and red 201 LED may indicate “PASS” and “FAIL” results of the interrogation respectively. In another embodiment, an audible alarm 230 may indicate the result of the interrogation. In another embodiment, PASS/FAIL information may be transmitted to the user with an integrated display 210 by displaying alphanumeric characters (words), in any appropriate language. The interrogator device may be packaged in any number of ways that provide for the interrogation light to exit and be delivered to the taggant, and for the signal light to enter and be delivered to (impinge on) the appropriate sensors (photodetectors). FIG. 19 shows a center of the measurement end of the housing 110. Housing windows may be transparent optical flats or lenses to increase collection efficiency or provide focusing to allow light to enter and exit the invention while maintaining a sealed environment for the internal components and circuitry. Further, the interrogator may have a “focused distance indicator” at the measurement end of the housing 110 to indicate where to place the unit relative to the taggant. Further, the interrogator may have a “safety shield” on the measurement end to prevent inadvertent eye exposure to IR light, wherein the safety shield may be made of a transparent plastic or an opaque plastic with a slit or hole to pass the taggant signature.

In another embodiment of the invention, the interrogator may be designed to look like a typical PDA organizer (or other nondescript electrical object, potentially even a pair of eye glasses) with attachments such as the Veo photo traveler. Additional communications, recording, input and user interface features may be integrated to increase the performance and utility of the invention. A primary high-level design, which would accommodate components and circuitry to perform several detailed measurements, could be used to serve a number of applications. Fully equipped with all of its elements, this embodiment of the invention would provide the maximum measurement capability. By integrating fewer components and features however, the invention could address lower end measurement applications which are either more cost sensitive or which do not require rigorous analysis.

What is claimed is:

1. A system of a multi-measurement interrogator and a taggant, the system comprising:
the taggant that is part of an article and is separate from the multi-measurement interrogator; and
the multi-measurement interrogator that includes,
memory,
an emitter to emit an eye-safe radiant energy on the taggant with sufficient energy to photochemically excite the taggant across a gap between the multi-measurement interrogator and the taggant that is greater than one one-hundredth of an inch in an open environment and to modulate the eye-safe radiant energy at a frequency, wherein the taggant uses the eye-safe radiant energy to generate a photochemical response signal,
an optical sensing subsystem capable to sense more than one type of the photochemical response signal from the taggant, wherein the optical sensing subsystem includes,
bandpass filters to select a spectral band of the photochemical response signal and to increase signal-to-noise ratio,
collecting optics to image a signal energy of the photochemical response signal and increase collection efficiency, and
a detector to detect and to perform temporal filtering of the photochemical response signal by lock-in detecting of the photochemical response signal at the same frequency of the modulated eye-safe radiant energy, wherein the detector is situated behind the bandpass filters and the collecting optics,
a detector central processing unit to compare a measured electrical signal corresponding to the photochemical response signal with an electrical signal stored in the memory, and
a distance interrogator situated on a measurement end of the multi-measurement interrogator to indicate where to place the multi-measurement interrogator relative to the taggant.

2. The system of claim 1, wherein at least one type of the response signal from the taggant is an upconversion fluorescence.

3. The system of claim 1, wherein the emitter comprises at least one light emitting diode.

4. The system of claim 3, wherein the light emitting diode is a bare semiconductor chip mounted on a heat sink with a lens placed substantially close to an emitting aperture of the chip to substantially reduce losses of the radiant energy.

5. The system of claim 1, the photochemical response signal includes a plurality of signals at different wavelengths.

6. The system of claim 1, wherein the multi-measurement interrogator further includes:
a shroud to prevent stray ambient light from interacting with the taggant during measurement and to limit ambient spectral contributions to the taggant signal in response to the emitter excitation that may contribute to a false signal strength to a taggant analysis.

7. The system of claim 1, wherein the distance interrogator is a focused distance interrogator.

8. A eye-safe system of an eye-safe interrogator and a taggant, the eye-safe system comprising:
the taggant that is part of an article and is separate from the multi-measurement interrogator; and
the multi-measurement interrogator that includes, memory;
a light emitting diode to emit an eye-safe light, the light emitting diode being capable to excite one or more of a Stoke's fluorescence and an upconversion fluorescence from a taggant across a gap between the multi-measurement interrogator and the taggant that is greater than one one-hundredth of an inch in an open environment and to modulate the eye-safe light at a frequency, wherein the taggant uses the eye-safe light to generate a photochemical response signal and the photochemical response signal is the one or more of a Stoke's fluorescence and an upconversion fluorescence,
an optical sensing subsystem capable to sense more than one type of a response signal from the taggant, wherein the optical sensing subsystem includes,
bandpass filters to select a spectral band of the photochemical response signal and to increase signal-to-noise ratio,
collecting optics to image a signal energy of the photochemical response signal and increase collection efficiency, and
a detector to detect and to perform temporal filtering of the photochemical response signal by lock-in detecting of the photochemical response signal at the same frequency of the modulated eye-safe light, wherein the detector is situated behind the bandpass filters and the collecting optics,
a detector central processing unit to compare a measured electrical signal corresponding to the response signal with an electrical signal stored in the memory, and
a distance interrogator situated on a measurement end of the eye-safe interrogator to indicate where to place the eye-safe interrogator relative to the taggant.

9. The eye-safe system of claim 8, wherein the light emitting diode is a bare semiconductor chip mounted on a heat sink with a lens placed substantially close to an emitting aperture of the chip to substantially reduce losses of the radiant energy.

10. The eye-safe system of claim 8, wherein the light emitting diode is a bare semiconductor chip mounted on a heat sink with a lens placed substantially close to an emitting aperture of the chip to substantially reduce losses of the radiant energy.

11. The eye-safe system of claim 8, the photochemical response signal includes a plurality of signals at different wavelengths.

12. The system of claim 8, wherein the multi-measurement interrogator further includes:
a shroud to prevent stray ambient light from interacting with the taggant during measurement and to limit ambient spectral contributions to the taggant signal in response to the emitter excitation that may contribute to a false signal strength to a taggant analysis.

13. The system of claim 8, wherein the distance interrogator is a focused distance interrogator.

14. A system of a portable covert interrogator and a taggant, the system comprising:
the taggant that is part of an article and is separate from the portable covert interrogator; and
the portable covert interrogator that includes, memory;
an emitter to emit an eye-safe invisible light, the emitter being capable to photochemically excite the taggant across a gap between the portable covert interrogator and the taggant that is greater than one one-hundredth of an inch in an open environment and to modulate the eye-safe invisible light at a frequency, wherein the taggant uses the eye-safe invisible light to generate a photochemical response signal,
an optical sensing subsystem capable to sense more than one type of a response signal from the taggant, wherein the optical sensing subsystem includes,
bandpass filters to select a spectral band of the photochemical response signal and to increase signal-to-noise ratio,
collecting optics to image a signal energy of the photochemical response signal and increase collection efficiency, and
a detector to detect and to perform temporal filtering of the photochemical response signal by lock-in detecting of the photochemical response signal at the same frequency of the modulated eye-safe invisible light, wherein the detector is situated behind the bandpass filters and the collecting optics,
a detector central processing unit to compare a measured electrical signal corresponding to the response signal with an electrical signal stored in the memory, and
a distance interrogator situated on a measurement end of the eye-safe interrogator to indicate where to place the portable covert interrogator relative to the taggant.

15. The system of claim 14, wherein at least one type of the response signal from the taggant is an upconversion fluorescence.

16. The system of claim 14, wherein the emitter comprises at least one light emitting diode.

17. The system of claim 16, wherein the light emitting diode is a bare semiconductor chip mounted on a heat sink with a lens placed substantially close to an emitting aperture of the chip to substantially reduce losses of the radiant energy.

18. The system of claim 14, wherein the multi-measurement interrogator further includes:
a shroud to prevent stray ambient light from interacting with the taggant during measurement and to limit ambient spectral contributions to the taggant signal in response to the emitter excitation that may contribute to a false signal strength to a taggant analysis.

19. The system of claim 14, wherein the distance interrogator is a focused distance interrogator.
